(19) United States
(12) Patent Application Publication
(10) Pub. No.: US 2009/0031981 A1
(43) Pub. Date: Feb. 5, 2009

(54) Intake system

(75) Inventor: Naoki Osumi, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/213,059

(22) Filed: Jun. 13, 2008

(30) Foreign Application Priority Data
Aug. 1, 2007 (JP) 2007-200998

(51) Int. Cl. F02M 35/10

(52) U.S. Cl. 123/184.57

(57) ABSTRACT

An intake system supplies intake air to a combustion chamber of an engine. The system includes a thin film part and a wall portion. The thin film part divides a surge tank from a resonance chamber and is configured to promote the supply of intake air to the combustion chamber by resonating with a suction pulse, which is generated as a result of the supply of intake air to the combustion chamber. The wall portion is different from the thin film part and has an opening, through which the surge tank communicates with the resonance chamber.

### CROSS REFERENCE TO RELATED APPLICATION

This application is based on and incorporates herein by reference Japanese Patent Application No. 2007-200998 filed on Aug. 1, 2007.

### BACKGROUND OF THE INVENTION

1. Field of the Invention

The present invention relates to an intake system, which supplies intake air to a combustion chamber of an engine.

2. Description of Related Art

Conventionally, an intake system having a torque-rise resonator is publicly known. The torque-rise resonator resonates with a suction pulse produced by the intake of air to promote the intake of air, thereby improving an engine output. According to the conventional torque-rise resonator, a resonance chamber is provided separately from an intake manifold, and a communicating passage, through which a surge tank of the intake manifold and the resonance chamber communicate, is formed. By generating a resonant wave in the communicating passage, the intake of air is promoted (see, for example, JP2-199265A).

However, since the torque-rise resonator requires an installing space in addition to the space for the intake manifold, a mount area in a limited engine compartment for the intake system becomes large. Therefore, the intake system having such a torque-rise resonator runs counter to a recent request for reduction in the mount area for apparatuses in the engine compartment.

### SUMMARY OF THE INVENTION

The present invention addresses the above disadvantages. Thus, it is an objective of the present invention to provide an intake system, which reduces a mount area for apparatuses in an engine compartment.

To achieve the objective of the present invention, there is provided an intake system that is configured to supply intake air to a combustion chamber of an engine. The system includes a thin film part and a wall portion. The thin film part divides a surge tank from a resonance chamber and is configured to promote the supply of intake air to the combustion chamber by resonating with a suction pulse, which is generated as a result of the supply of intake air to the combustion chamber. The wall portion is different from the thin film part and has an opening, through which the surge tank communicates with the resonance chamber.

### BRIEF DESCRIPTION OF THE DRAWINGS

The invention, together with additional objectives, features and advantages thereof, will be best understood from the following description, the appended claims and the accompanying drawings in which:

FIG. 1 is a schematic diagram illustrating a configuration of an intake system according to a first embodiment of the invention;

FIG. 2 is a schematic diagram illustrating a configuration of an intake system according to a second embodiment of the invention;

FIG. 3 is a schematic diagram illustrating a configuration of an intake system according to a third embodiment of the invention;

FIG. 4 is an operating-characteristics diagram illustrating a correlation between a pressure of a surge tank and a degree of opening of an internal flow passage according to the third embodiment;

FIG. 5 is an operating-characteristics diagram illustrating a correlation between a pressure of a surge tank and a degree of opening of an internal flow passage according to a fourth embodiment of the invention; and

FIG. 6 is an operating-characteristics diagram illustrating a correlation between a rotational speed of an engine and the degree of opening of the internal flow passage according to the fourth embodiment.

### DETAILED DESCRIPTION OF THE INVENTION

An intake system according to a first embodiment of the invention supplies intake air to a combustion chamber of an engine, and includes a thin film part. The thin film part divides a surge tank from a resonance chamber, and resonates with a suction pulse produced by the intake of air into the combustion chamber to promote the intake of air into the combustion chamber. The surge tank and the resonance chamber communicate through an opening that is formed in a wall portion, which is different from the thin film part. Accordingly, the intake system promotes the intake of air not by generating the resonant wave in the communicating passage as in the case of the conventional torque-rise resonator, but by generating the resonant wave using the thin film part. Thus, it is possible for the resonance chamber to be located adjacent to the surge tank or to project into the inside of the surge tank. As a result, an installing space for the torque-rise resonator is decreased, so that a mount area in an engine compartment for apparatuses can be reduced. In addition, the opening is a through hole passing through the wall portion which divides the surge tank from the resonance chamber.

According to an intake system of a second embodiment of the invention, a first opening, through which a surge tank is opened to the outside, and a second opening, through which a resonance chamber is opened to the outside serve as the above opening. The surge tank and the resonance chamber communicate via a passages forming member, which connects the first and second openings.

An intake system according to a third embodiment of the invention includes a valve body, which opens and closes a internal flow passage of a passages forming member, an actuator, which drives the valve body, and a control means for controlling a degree of opening of the internal flow passage by commanding the actuator to drive the valve body. The control means sets a threshold value for pressure of the surge tank. The control means controls the degree of opening of the internal flow passage to be fully closed when the pressure of the surge tank is larger than the threshold value, and controls the degree of opening of the internal flow passage to be fully open when the pressure of the surge tank is smaller than the threshold value.

According to an intake system of a fourth embodiment of the invention, a control means controls a degree of opening of an internal flow passage according to a rotational speed of an engine when pressure of a surge tank is larger than a threshold value, and controls the degree of opening of the internal flow passage to be fully open when the pressure of the surge tank is smaller than the threshold value.

### First Embodiment

### Configuration of the First Embodiment

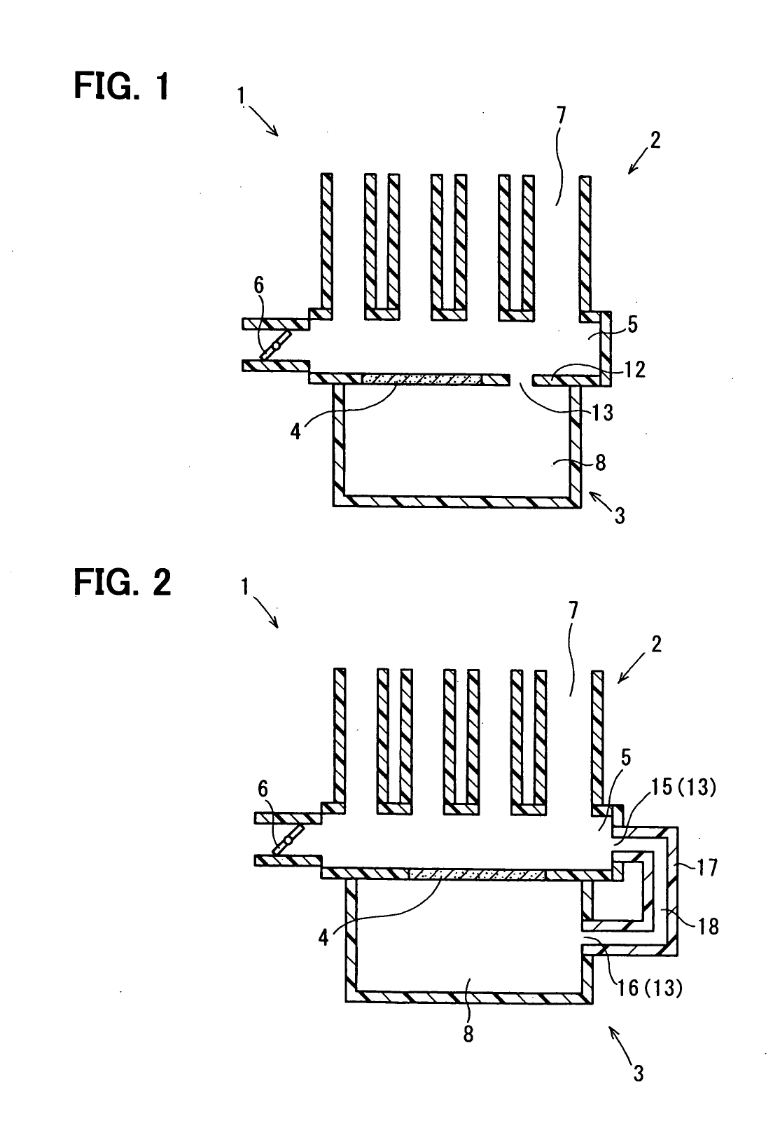

A configuration of an intake system 1 of the first embodiment is explained with reference to FIG. 1. The intake system 1 includes an intake manifold 2, which serves as a passage for intake air leading into a combustion chamber (not shown) of an engine (not shown), and a torque-rise resonator (hereinafter referred to as a resonator) 3, and the resonator 3 is attached to the intake manifold 2. The intake system 1 supplies intake air to the combustion chamber.

The resonator 3 promotes an intake of air so as to improve an engine output because its thin film part 4 resonates with a suction pulse produced by intake air. Intake air, whose flow is regulated by a throttle valve 6, is supplied to a surge tank 5 of the intake manifold 2. Then, the intake air in the surge tank 5 is conducted into the combustion chamber via each inlet port 7.

The thin film part 4 promotes the intake of air to the combustion chamber by dividing a surge tank 5 from a resonance chamber 8 and by resonating with the suction pulse produced by the intake of air into the combustion chamber, and consequently serves as the core of the resonator 3. The thin film part 4 has a predetermined resonance frequency Fo according to various specifications such as its own mass and volume of the resonance chamber 8. More specifically, the thin film part 4 resonates with a suction pulse having a frequency, which generally accords with the resonance frequency Fo, among suction pulses having various frequencies, so as to generate a resonant wave. The intake of air into the combustion chamber is promoted because of the resonant wave.

Furthermore, the surge tank 5 is divided from the resonance chamber 8 with a wall portion 12, which is different from the thin film part 4, too. The surge tank 5 and the resonance chamber 8 communicate through an opening 13 formed in the wall portion 12. The opening 13 is a through hole passing through the wall portion 12, and the surge tank 5 and the resonance chamber 8 constantly communicate through the through hole.

### Advantageous Effects of the First Embodiment

The intake system 1 of the first embodiment includes the thin film part 4, which promotes the intake of air to the combustion chamber by dividing the surge tank 5 from the resonance chamber 8 and by resonating with the suction pulse produced by the intake of air to the combustion chamber. The surge tank 5 and the resonance chamber 8 communicate through the opening 13 formed in the wall portion 12.

Accordingly, the intake system 1 generates the resonant wave using the thin film part 4 to promote the intake of air. Thus, an installing space for the resonator 3 is reduced by locating the resonance chamber 8 adjoining the surge tank 5, so that an installation area for apparatuses in an engine compartment is reduced.

Moreover, in the case of the generation of the resonant wave by the thin film part 4, the thin film part 4 may be damaged when a differential pressure ΔP between a pressure Ps of the surge tank 5 and a pressure Pch of the resonance chamber 8 increases. By making the surge tank 5 and the resonance chamber 8 communicate through the opening 13 so as to decrease the differential pressure ΔP, the possibility that the thin film part 4 may be damaged is decreased.

In addition, the opening 13 is a through hole passing through the wall portion 12, which divides the surge tank 5 from the resonance chamber 8 besides the thin film part 4. As a result, another passage, through which the surge tank 5 and the Resonance chamber 8 communicate, does not need to be installed. Thus, the possibility of the damage to the thin film part 4 is made small using a simple configuration without increasing an installation area for the intake system 1.

### Second Embodiment

According to an intake system 1 of the second embodiment, as shown in FIG. 2, a first opening 15, through which the surge tank 5 is opened to the outside, and a second opening 16, through which the resonance chamber 8 is opened to the outside, serve as the opening 13. A passage forming member 17 is connected between the first opening 15 and the second opening 16, and the surge tank 5 and the Resonance chamber 8 communicate through an internal flow passage 18 of the passage forming member 17.

### Third Embodiment

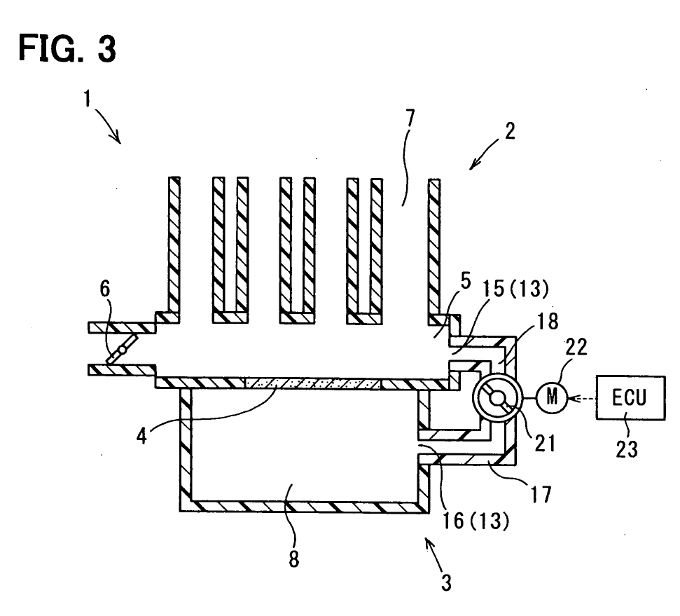

As shown in FIG. 3, an intake system 1 of the third embodiment includes a valve body 21, which opens and closes the internal flow passage 18, an actuator 22, which drives the valve body 21, and an electronic control unit (ECU) 23 as a control means for controlling a degree of opening of the internal flow passage 18 by commanding the actuator 22 to drive the valve body 21. The ECU 23 is configured as a widely known microcomputer including a central processing unit (CPU) having a control function and a calculation function, storage units such as read-only memory (ROM) and random access memory (RAM), an input device, and an output device. The actuator 22 is a widely known electric motor, which is energized in accordance with a control signal outputted from the ECU 23 to generate driving force for driving the valve body 21.

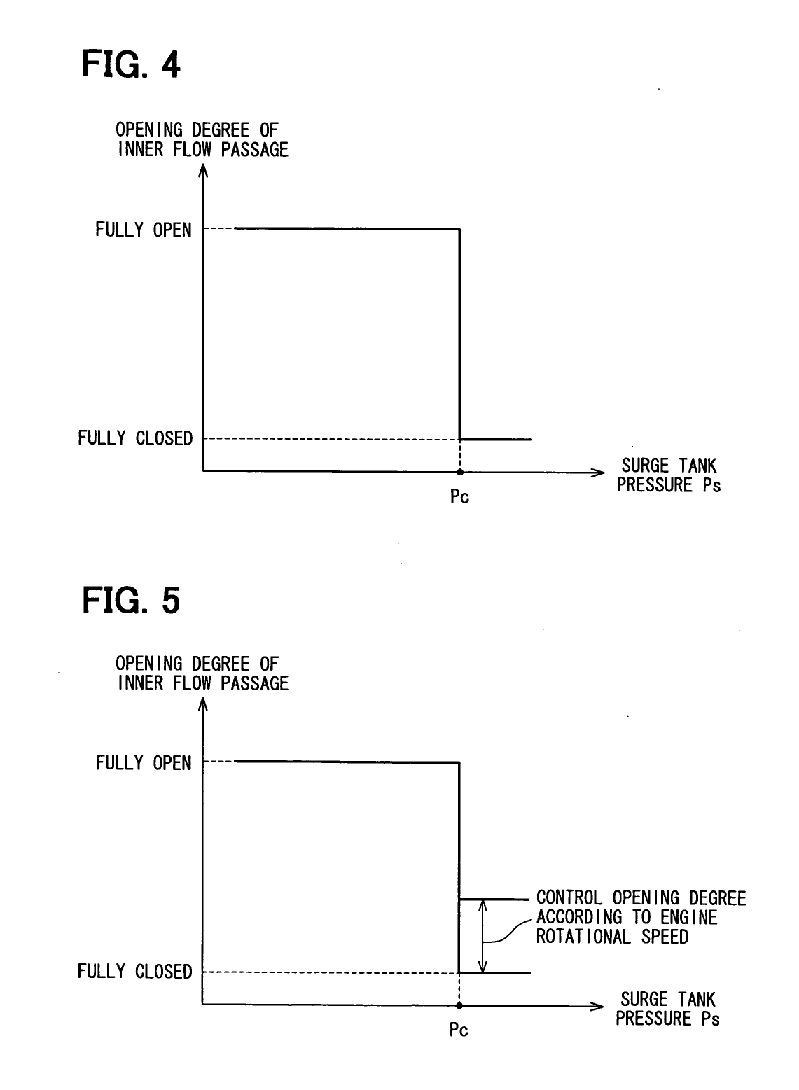

The ECU 23 obtains an actual value of the pressure Ps in the surge tank 5 by a predetermined pressure sensor (not shown), and sets and stores a threshold value Pc with respect to the actual value of the pressure Ps. As shown in FIG. 4, the ECU 23 controls the degree of opening of the internal flow passage 18 to be fully closed when the actual value of the pressure Ps is larger than the threshold value Pc, and controls the degree of opening of the internal flow passage 18 to be fully open when the actual value of the pressure Ps is smaller than the threshold value Pc.

The pressure Pch in the resonance chamber 8 is constantly kept approximately at an atmospheric pressure irrespective of an engine load, while the pressure Ps in the surge tank 5 easily varies according to the engine load. More specifically, the pressure Ps is easily reduced to a negative pressure, which is smaller than the atmospheric pressure, because a throttle opening degree is small when the engine is in low-load operation, and the pressure Ps is equal to the atmospheric pressure because the throttle opening degree is large when the engine is in high-load operation.

Accordingly, when the pressure Ps is small, the differential pressure ΔP becomes large, so that a possibility that the thin film part 4 may be damaged is made strong. Conversely, when the pressure Ps is large, the differential pressure ΔP becomes small, so that a possibility that the thin film part 4 may be damaged is decreased.

Consequently, by establishing a procedure in the ECU 23 as described above, the internal flow passage 18 is fully opened to decrease the differential pressure ΔP only when the possibility of the damage to the thin film part 4 is strong, and the internal flow passage 18 is closed not to decrease a promoting effect on the intake of air due to the resonant wave when the possibility of the damage to the thin film part 4 is small. The time when the possibility of the damage to the thin film part 4 is small is when the engine is in high-load operation, and thus accords with the time when the intake of air needs to be promoted. Therefore, in the above manner, by closing the internal flow passage 18 when the intake of air needs to be promoted, the effect of decreasing the possibility of the damage to the thin film part 4 with the promoting effect on the intake of air maintained is produced.

### Fourth Embodiment

According to an intake system of the fourth embodiment, as shown in FIG. 5, an ECU 23 controls a degree of opening of an internal flow passage 18 according to a rotational speed of the engine when an actual value of a pressure Ps of a surge tank 5 is larger than a threshold value Pc, and controls the degree of opening of the internal flow passage 18 to be fully opened when the actual value of the pressure Ps is smaller than the threshold value Pc.

Accordingly, by operating the resonance frequency Fo through changing the degree of opening of the internal flow passage 18 into a fully closed degree or into a degree, which is on an open side with respect to the fully closed degree, when the engine is in high-load operation, the resonance frequency Fo generally accords with the frequency of the suction pulse. Thus, the promoting effect on the intake of air is not reduced when the engine is in high-load operation to promote the intake of air.

If the opening degree of the internal flow passage is fixed at the fully closed degree, a deviation of the frequency of the suction pulse from the resonance frequency Fo becomes great due to a variation of the engine rotational speed because the frequency of the suction pulse decreases with the engine rotational speed, and consequently the effect of promoting the intake of air may decrease. As a result of establishing the procedure in the ECU 23 as described above, when the engine is in high-load operation to promote the intake of air, the resonance frequency Fo generally accords with the frequency of the suction pulse by varying the resonance frequency Fo through changing the degree of opening of the internal flow passage 18 to a fully closed degree or to a degree, which is on an open side with respect to the fully closed degree. Accordingly, the promoting effect on the intake of air is maintained.

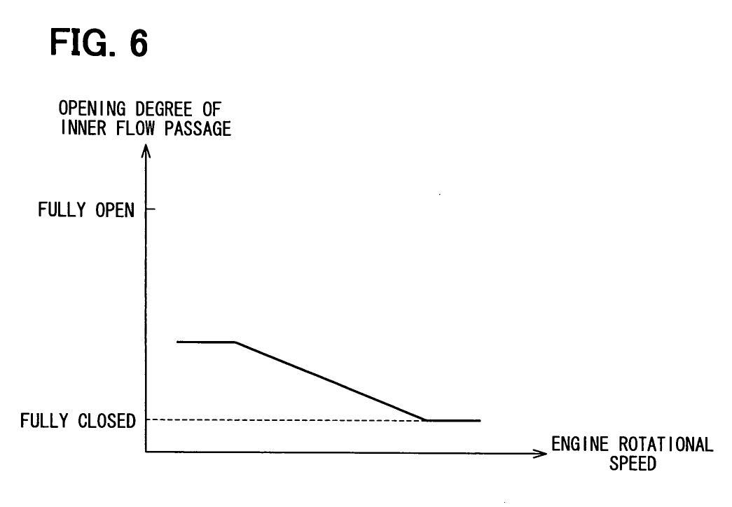

More specifically, when the engine is in high-load operation, as shown in FIG. 6, the degree of opening of the internal flow passage 18 is increased to the open side as the engine rotational speed is smaller so as to decrease the resonance frequency Fo. As the engine rotational speed is larger, the degree of opening of the internal flow passage 18 is decreased to its closed side so as to increase the resonance frequency Fo. As a result, when the engine is in high-load operation to promote the intake of air, the resonance frequency Fo is made to generally accord with the frequency of the suction pulse by changing the degree of opening of the internal flow passage 18 to vary the resonance frequency Fo. Accordingly, the promoting effect on the intake of air is maintained.

### Modifications

According to the intake system 1 of the first embodiment, the resonance chamber 8 is formed adjacent to the surge tank 5. Alternatively, the resonance chamber 8 may be formed to project into the inside of the surge tank 5. Furthermore, the number of frequencies, with which the resonator 3 can resonate, may be increased by providing more than one thin film part 4 instead of a single thin film part 4.

Additional advantages and modifications will readily occur to those skilled in the art. The invention in its broader terms is therefore not limited to the specific details, representative apparatus, and illustrative examples shown and described.

What is claimed is:

1. An intake system that is configured to supply intake air to a combustion chamber of an engine, the system comprising:
a thin film part that divides a surge tank from a resonance chamber and is configured to promote the supply of intake air to the combustion chamber by resonating with a suction pulse, which is generated as a result of the supply of intake air to the combustion chamber; and
a wall portion that is different from the thin film part and has an opening, through which the surge tank communicates with the resonance chamber.

2. The intake system according to claim 1, wherein the opening includes a first opening, through which the surge tank communicates with an outside of the surge tank, and a second opening, through which the resonance chamber communicates with an outside of the resonance chamber, the system further comprising a passage forming member that connects the first opening and the second opening, so that the surge tank communicates with the resonance chamber via the passage forming member.

3. The intake system according to claim 2, further comprising:
a valve body that is configured to open and close an internal flow passage, which is formed in the passage forming member;
an actuator that drives the valve body; and
a control means for controlling an opening degree of the internal flow passage by commanding the actuator to drive the valve body, wherein:
the control means sets a threshold value for a pressure of the surge tank;
the control means controls the opening degree of the internal flow passage to be fully closed when the pressure of the surge tank is larger than the threshold value; and
the control means controls the opening degree of the internal flow passage to be fully open when the pressure of the surge tank is smaller than the threshold value.

4. The intake system according to claim 2, further comprising:
a valve body that is configured to open and close an internal flow passage, which is formed in the passage forming member;
an actuator that drives the valve body; and
a control means for controlling an opening degree of the internal flow passage by commanding the actuator to drive the valve body, wherein:
the control means sets a threshold value for a pressure of the surge tank;
the control means controls the opening degree of the internal flow passage in accordance with a rotational speed of the engine when the pressure of the surge tank is larger than the threshold value; and
the control means controls the opening degree of the internal flow passage to be fully open when the pressure of the surge tank is smaller than the threshold value.

5. The intake system according to claim 1, wherein:
the opening is a through hole that penetrates through the wall portion; and
the wall portion divides the surge tank from the resonance chamber.
